(19) United States
(12) Patent Application Publication
(10) Pub. No.: US 2021/0010508 A1
(43) Pub. Date: Jan. 14, 2021

(54) DUMBELL-LIKE SHAPED SYMMETRICAL BIDIRECTIONAL TAPERED THREAD CONNECTION PAIR

(71) Applicant: AMICUS VERITATIS MACHINERY CO., LTD., Taizhou (CN)

(72) Inventor: Yihua YOU, TAIZHOU (CN)

(21) Appl. No.: 17/036,511

(22) Filed: Sep. 29, 2020

Related U.S. Application Data
(63) Continuation of application No. PCT/CN2019/081397, filed on Apr. 4, 2019.

(30) Foreign Application Priority Data
Apr. 7, 2018 (CN) 201810303100.X

(51) Int. Cl. F16B 33/02

(52) U.S. Cl. CPC F16B 33/02

(57) ABSTRACT

The invention belongs to the field of general technology of device, and relates to a dumbbell-like shaped symmetrical bidirectional tapered thread connection pair, which solves the problem of poor self-positioning and self-locking of existing threads. An internal thread (6) is a bidirectional tapered hole (41) (non-entity space) on an inner surface of a cylindrical body (2), an external thread (9) is a bidirectional tapered cone body (71) (material entity) on an outer surface of a columnar body (3), and a complete unit thread a dumbbell-like shaped symmetrical bidirectional tapered body having a left taper (95) same as and/or approximately same as a right taper (96).

### CROSS-REFERENCE TO RELATED APPLICATIONS

This application is a continuation of International Patent Application No. PCT/CN2019/081397 with a filing date of Apr. 4, 2019 designating the United States, now pending, and further claims priority to Chinese Patent. Application No. 201810303100.X with a filing date of Apr. 7, 2018. The content of the aforementioned applications, including any intervening amendments thereto, are incorporated herein by reference.

### TECHNICAL FIELD

The present invention belongs to the field of general technology of device, and more particularly, relates to, a dumbbell-like shaped symmetrical bidirectional tapered thread connection pair.

### BACKGROUND OF THE INVENTION

The invention of thread has a profound impact on the progress of human society. Thread is one of the most basic industrial technologies. It is not a specific product, but a key generic technology in the industry. It has the technical performance that, must be embodied by specific products as application carriers, and, is widely applied in various industries. The existing thread technology has high standardization level, mature technical theory and long-term practical application. It is a fastening thread when, used for fastening, a sealing thread when used for sealing, and a transmission thread when used for transmission. According to the thread terminology of national standards, “thread” refers to a tooth body with the same thread form and continuously raising along a helical line on a cylindrical or conical surface; and “tooth body” refers to a material entity between adjacent tooth sides. This is also the definition of thread under global consensus.

Modern threads began in 1841 with Whitworth thread in England. According to the theory of modern thread technology, the basic condition for self-locking of the thread is that an equivalent friction angle shall not be smaller, than a helix angle. This is an understanding for the thread technology in modern thread based on a technical principle-“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to a horizontal plane, a helix is the deformation of the “inclined plane”, and a thread is like the inclined plane wrapped outside a cylinder. The flatter the inclined plane is, the greater a mechanical benefit is (see FIG. 8 (Yang Jingshan, Wang Xiuya, “Discussion on the Principle of Screw”. “Research on Gauss Arithmetic”).

The “principle of inclined plane” of the modern thread is an inclined plane slider model (see FIG. 9 which is established based on the law of inclined plane. It is believed that the thread pair meets the requirements of self-locking when a thread rise angle is less than or equal to the equivalent friction angle under the condition of little change of static load and temperature. The thread rise angle (see FIG. 10 also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

There are many types and forms of modern threads, all of which are tooth-shaped threads, which are determined by the technical principle thereof, i.e., the principle of inclined plane. Specifically, threads formed on cylindrical surfaces are called cylindrical threads, threads formed on conical surfaces are called conical threads, and threads formed on end surfaces, of cylinders or truncated cone bodies are called plane threads. Threads formed on excircle surfaces of bodies are called external threads, threads formed on inner round hole surfaces of the bodies are called internal threads, and threads formed on end surfaces of the bodies are called end threads. Threads having a rotation direction and a thread rise angle direction conforming to the left-hand rule are called left-hand threads, while those having a rotation direction and a thread rise angle direction conforming to the right-hand rule are called right-hand threads. Threads with only one helical line in, the same cross section of the body are called single thread, those with two helical lines are called double; start threads, while those with multiple helical lines are called multi-start threads. Threads with triangular cross-sections are called triangular threads, those with trapezoidal cross-sections are called trapezoidal threads, those, with rectangular cross-sections are called rectangular threads, while those with sawtooth cross-sections are called sawtooth threads.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a dumbbell-like shaped symmetrical bidirectional tapered thread connection pair with the advantages of reasonable design, simple structure, and excellent connection performance and locking performance with respect to the above problems.

To achieve the above object, the following technical solution is adopted in the present invention: the dumbbell-like shaped symmetrical bidirectional tapered thread connection pair refers to a special thread pair technology combining, technical characteristics of a cone pair and a helical movement, and a thread connection pair formed by a symmetrical bidirectional tapered external thread and a symmetrical bidirectional tapered internal thread is used. The bidirectional tapered body is composed of two single tapered bodies which are respectively located at left and right sides of the bidirectional tapered body. Namely, the bidirectional tapered body is bidirectionally composed of two single tapered bodies in two directions, wherein the tapered body has a left taper and a right taper opposite in directions and same and/or approximately same in tapers. The bidirectional tapered body is helically distributed on an outer surface of the columnar body to form the external thread and/or the bidirectional tapered body is helically distributed on an inner surface of the cylindrical body to form the internal thread, and a complete unit thread of the external thread is a dumbbell-like shaped special bidirectional tapered geometry small in the middle and large in both ends and having a left taper same as and/or approximately same as a right taper no matter the bidirectional tapered body is the internal thread or the external thread.

For the dumbbell-like shaped symmetrical bidirectional tapered thread connection pair, the definition of the dumbbell-like shaped symmetrical bidirectional tapered thread may be expressed as: “a dumbbell-like shaped special helical bidirectional tapered geometry on a cylindrical or conical surface, which is small in the middle and large in both ends and has the symmetrical bidirectional tapered holes (or symmetrical bidirectional truncated cone bodies) with the specified left and right tapers opposite in directions and same and/or approximately same in tapers, and the symmetrical bidirectional tapered holes (or symmetrical bidirectional truncated cone bodies) are continuously and/or discontinuously distributed along the helical line”. The head or the tail of the symmetrical bidirectional tapered thread may be an incomplete bidirectional tapered geometry due to manufacturing and other reasons. Different from the modern thread technology, in terms of the number of complete unit threads and/or incomplete unit threads, the bidirectional taper threads are no longer in terms of “number of teeth”, but in terms of “number of pitches”, that is, the bidirectional taper threads are no longer called threads in teeth, but are threads in pitches. This change in the title of the number of threads is based on the change in the connotation of the thread technology, and the thread technology has changed from the engagement relationship between the internal thread and the external thread in the modern thread to the cohesion relationship between the internal thread and the external thread in the bidirectional tapered thread.

The dumbbell-like shaped symmetrical bidirectional tapered thread connection pair comprises a bidirectional truncated cone body helically distributed on an outer surface of a columnar body, and a bidirectional tapered hole helically distributed on an inner surface of a cylindrical body, i.e., comprises an external thread and an internal thread in mutual thread fit, wherein the internal thread is presented by the helical bidirectional tapered hole and exists in a form of a “non-entity space” while the external thread is, presented by the helical bidirectional truncated cone body and exists in a form of a “material entity”. The non-entity space refers to a space environment capable of accommodating the above material entity. The internal thread is a containing part; and the external thread is a contained part. A working state of the thread is as follows: the internal thread and the external thread are sleeved together by screwing bidirectional tapered geometries in pitches, and the internal thread is cohered with the external thread until one side bears the load bidirectionally or the left side and the right side bear the load bidirectionally at the same time or till interference fit. Whether the two sides bear bidirectional load at the same time is related to the actual working conditions in the application field, and the bidirectional tapered hole contains and is cohered with the bidirectional truncated cone body in pitches, i.e., the internal thread is cohered with the corresponding external thread in pitches.

The thread connection pair is a thread pair formed by fitting a helical outer conical surface with a helical inner conical surface to form a cone pair. An outer conical surface of an external cone body of the bidirectional tapered thread is a bidirectional conical surface. When the thread connection pair is formed between the bidirectional tapered external thread and a traditional internal thread, a joint surface between a special conical surface of the traditional internal thread and the outer conical surface of the bidirectional tapered external thread is used as a bearing surface, i.e., the conical surface is used as the bearing surface to realize the technical performance of connection. The self-locking, self-positioning, reusability, fatigue resistance and other capabilities of the thread pair mainly depend on size of the conical surfaces forming the cone pair of the dumbbell-like shaped symmetrical bidirectional tapered thread connection pair as well as size of the conical surfaces thereof, i.e., sizes of the conical surfaces of the internal and external threads as well as tapers thereof, and the thread connection pair is a non-toothed thread.

Different from that the principle of inclined plane of the existing thread which shows a unidirectional force distributed on the inclined plane as well as an engagement relationship between the internal tooth bodies and the external tooth bodies, the bidirectional tapered body of the dumbbell-like shaped symmetrical bidirectional tapered thread connection pair is composed of two plain lines of the cone body in two directions (i.e. bidirectional state) when viewed from any cross section of the single cone body distributed on either left or right side along the cone axis. The plain line is the intersection line of the conical surfaces and a plane through which the cone axis passes. The cone principle of the dumbbell-like shaped symmetrical bidirectional tapered thread connection pair shows an axial force and a counter-axial force, both of which are combined by bidirectional forces, wherein the axial force and the corresponding counter-axial force are opposite to each other. The internal thread and the external thread are in a cohesion relationship. Namely, the thread connection pair is formed by cohering the external thread with the internal, thread, i.e., the tapered hole (internal cone) is cohered with the corresponding cone body (external cone body) pitch by pitch till the self-positioning is realized by cohesion fit or till the self-locking is realized by interference contact. Namely, the self-locking or self-positioning of the internal cone body and the external cone body is realized by radially cohering the special tapered hole and the truncated cone body to realize the self-locking or self-positioning of the thread pair, rather than the thread connection pair, composed of the internal thread and the external thread in the traditional thread, which realizes a thread connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the bidirectional tapered thread technology, i.e., the cone pair technology, in the present invention.

The internal cone body exists in a form similar to a shaft sleeve, and generates the axial force pointing to or pressing toward the cone axis under the action of external load. The axial force is bidirectionally combined by a pair of centripetal forces which are distributed in mirror, image with the cone, axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two, sides of the thread axis in mirror image and/or approximate mirror image with the thread axis as the center, are respectively perpendicular to the two plain lines of the cone body, and point to or press toward the common point and/or approximate common point of the thread, axis when, the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are cohered till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be cohered with the external cone body to forma similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. However, not any axial force angle and/or counter-axial force angle may enable the cone pair to generate self-locking and self-positioning.

When the axial force angle and/or the counter-axial force angle less, than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation till the cone pair completely has no self-locking ability: and the axial bearing capacity changes in a direction of enhancement till the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation till the cone pair is close to have has no self-positioning ability at all.

Comparing the bidirectional tapered thread connection pair with the containing and contained relationship of irreversible one-sided bidirectional containment that the unidirectional tapered thread of single tapered body invented by the applicant before which can only bear the load by one side of the conical surface, the reversible left and right-sided bidirectional containment of the bidirectional tapered threads of double tapered bodies enables the left side and/or the right side of the conical surface to bear the load, and/or the left conical surface and the right conical surface to respectively bear the load, and/or the left conical surface and the right conical surface to simultaneously bear the load bidirectionally, and further limits a disordered degree of freedom between the tapered hole and the truncated cone body; and a helical movement enables the symmetrical bidirectional tapered thread connection pair to obtain a necessary ordered degree of freedom, thereby effectively combining the technical characteristics of the cone pair and, the thread pair to form a brand-new thread technology.

When the dumbbell-like shaped symmetrical bidirectional tapered thread, connection pair is used, the conical surface of the bidirectional truncated cone body of the external thread of the bidirectional tapered thread is in mutual fit with the conical surface of the bidirectional tapered hole of the internal thread in the bidirectional tapered thread.

The self-locking and/or self-positioning of the thread connection pair is not realized at any taper or any taper angle of the truncated cone body and/or the tapered hole, i.e., the bidirectional tapered body forming the cone pair of the dumbbell-like shaped symmetrical bidirectional tapered thread connection pair. The thread connection pair has the self-locking and self-positioning performances only if the internal and external cone body reach a certain taper or a certain taper angle. The taper comprises the left taper and the right taper of the internal and external threads. The taper angle comprises a left taper angle and a right taper angle of the internal and external threads. The left taper corresponds to the left taper angle. i.e., a first taper angle α1. It is preferable that the first taper angle α1 is greater than 0° and smaller than 53°; and preferably, the first taper angle α1 is 2°-40°. The right taper corresponds to the right taper angle, i.e., a second taper angle α2. It is preferable that the second taper angle α2 is greater than 0° and smaller than 53°; and preferably, the second taper angle α2 is 2°-40°. In individual special fields, it is preferable that the first taper angle α1 is greater than or equal to 53° and smaller than 180°, and the second taper angle α2 is greater than or equal to 53° and smaller than 180°. It is preferable that the first taper angle α1 and the second taper angle, α2 are 53°-90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

According to the dumbbell-like shaped symmetrical bidirectional tapered thread connection pair, the external thread is arranged on the outer surface of the columnar body, wherein the truncated cone body is helically distributed on the outer surface of the columnar body, comprising a dumbbell-like shaped symmetrical bidirectional truncated cone body. The columnar body may be solid or hollow, comprising cylindrical and/or non-cylindrical workpieces and objects that need to be machined with threads, on outer surfaces thereof, wherein the outer surfaces comprise geometric shapes of outer surfaces such as cylindrical surfaces, non-cylindrical surfaces such as conical surfaces, and the like.

According to the dumbbell-like shaped symmetrical bidirectional tapered thread connection pair, the symmetrical bidirectional truncated cone body, i.e., the external thread is formed by oppositely jointing two, symmetrical upper sides of two identical truncated cone bodies, and lower sides of the two identical truncated cone bodies are located at two ends of the bidirectional truncated cone body and are mutually jointed with the lower sides of the adjacent bidirectional truncated cone body and/or to be mutually jointed with the lower sides of the adjacent bidirectional truncated cone body. The external thread comprises a first helical conical surface of the truncated cone body, a second helical conical surface of the truncated cone body and an external helical line. In a cross section through which the thread axis passes, the complete single-pitch symmetrical bidirectional tapered external thread is a dumbbell-like shaped special bidirectional tapered geometry small in the middle and large in both ends and having a left taper same as and/or approximately same as a right taper. The symmetrical bidirectional truncated cone body comprises a conical surface of the bidirectional truncated cone body. An angle formed between two plain lines of a left conical surface of the bidirectional truncated cone body, i.e., the first helical conical surface of the truncated cone body, is the first taper angle α1. The left taper is formed on the first helical conical surface of the truncated cone body and is subjected to a right-direction distribution. An angle formed between two plain lines of a right conical surface of the symmetrical bidirectional truncated cone body, i.e., the second helical conical surface of the truncated cone body, is the second taper angle α2. The right taper is formed on the second helical conical surface of the truncated cone body and is subjected to a left-direction distribution. The taper directions corresponding to the first taper angle α1 and the second taper angle α2 are opposite. The plain line is an intersection line of the conical surface and the plane through which the cone axis passes. A shape formed by the first helical conical surface of the truncated cone body and the second helical conical surface of the truncated cone body of the bidirectional truncated cone body is the same as a shape of a helical outer flank of a rotating body, wherein the rotating body is formed by two hypotenuses of a right-angled trapezoid union being rotated around, a right-angled side of the right-angled trapezoid union, and, at the same time, the right-angled trapezoid union axially moves at a constant speed along a central axis of the columnar body; wherein the right-angled trapezoid union refers to a special geometry formed by oppositely jointing two symmetrical upper sides of two identical right-angled trapezoids, and lower sides of the two identical right-angled trapezoids are respectively located at two ends of the right-angled trapezoid union; and the two right-trapezoids are coincident with the central axis of the columnar body.

According to the dumbbell-like shaped symmetrical bidirectional tapered thread connection pair, the internal thread is arranged on the inner surface of the cylindrical body, wherein a tapered hole is helically distributed on the inner surface of the cylindrical body, comprising a dumbbell-like shaped symmetrical bidirectional tapered hole. The cylindrical body comprises cylindrical and/or non-cylindrical workpieces and objects that need to be machined with internal threads on inner surfaces thereof, wherein the inner surfaces comprise geometric shapes of inner surfaces such as cylindrical surfaces, non-cylindrical surfaces such as conical surfaces, and the like.

According to the dumbbell-like shaped symmetrical bidirectional tapered thread connection pair, the symmetric bidirectional tapered hole, i.e., the internal thread is formed by oppositely jointing two symmetrical upper sides of two identical tapered holes, and lower sides of the two identical tapered holes are located at two ends of the bidirectional tapered hole and are mutually jointed with the lower sides of the adjacent bidirectional tapered hole and/or to be mutually jointed with the lower sides of the adjacent bidirectional tapered hole. The internal thread comprises a first helical conical surface of the tapered hole, a second helical conical surface of the tapered hole and an internal helical line. In a cross section through which the thread axis passes, the complete single-pitch symmetrical bidirectional tapered internal thread is a dumbbell-like shaped special bidirectional tapered geometry small in the middle and large in both ends and having a left taper same as and/or approximately same as a right taper. The bidirectional tapered hole comprises a conical surface of the bidirectional tapered hole. An angle formed between two plain lines of a left conical surface of the bidirectional tapered hole, i.e., the first helical conical surface of the tapered hole, is the first taper angle α1. The left taper is formed on the first helical conical surface of the tapered hole and is subjected to a right-direction distribution. An angle formed between two plain lines of a right conical surface of the bidirectional tapered hole, i.e., the second helical conical surface of the tapered hole, is the second taper angle α2. The right taper is formed on the second helical conical surface of the tapered hole and is subjected to a left-direction distribution. The taper directions corresponding to the first taper angle α1 and the second taper angle α2 are opposite. The plain line is an intersection line of the conical surface and the plane through which the cone axis passes. A shape formed by the first helical conical surface of the tapered hole and the second helical conical surface of the tapered hole of the bidirectional tapered hole is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body; wherein the right-angled trapezoid union refers to a special geometry formed by oppositely jointing two symmetrical upper sides of two identical right-angled trapezoids, and lower sides of the two identical right-angled trapezoids are respectively located at two ends of the right-angled trapezoid union; and the two right-trapezoids are coincident with the central axis of the cylindrical body.

In the dumbbell-like shaped symmetrical bidirectional tapered thread connection pair, a joint of two adjacent helical conical surfaces of the external thread and a joint of two adjacent helical conical surfaces of the internal thread respectively are connected through connection forms such as cusp and/or non-cusp forms, and the cusp form is relative to the non-cusp form, which, refers to a structural form which is not specially subjected to non-cusp treatment.

In the dumbbell-like shaped symmetrical bidirectional tapered thread connection pair, when the cusp form is selected as the connection form, a joint between the first helical conical surface of the truncated cone body and the second helical conical surface of the truncated cone body of the same helical bidirectional truncated cone body, i.e., minor diameter of, the external thread is connected by adopting an internal-cusp shaped structure and the helically distributed external helical line is formed; a joint between the first helical conical surface of the truncated cone body of the same helical bidirectional truncated cone body and the second helical conical surface of the truncated cone body of the adjacent bidirectional truncated cone body and/or a joint between the second helical conical surface of the truncated cone body of the same helical bidirectional truncated cone body and the first helical conical surface of the truncated cone body of the adjacent bidirectional truncated cone body, i.e., a major diameter of the external thread is connected by adopting an external-cusp shaped structure and the helically distributed external helical line is formed; a joint between the first helical conical surface of the tapered hole and the second helical conical surface of the tapered hole of the same helical bidirectional tapered hole. i.e., a minor diameter of the internal thread is connected by adopting an external-cusp shaped structure and the helically distributed internal helical line is formed; a joint between the first helical conical surface of the tapered hole of the same helical bidirectional tapered hole and the second helical conical surface of the tapered hole of the adjacent bidirectional tapered hole and/or a joint between the second helical conical surface of the truncated cone body of the same helical bidirectional tapered, hole and the first helical conical surface of the tapered hole of the adjacent bidirectional tapered hole, i.e., a major diameter of the internal thread is connected by adopting an internal-cusp shaped structure and the helically distributed internal helical line is formed. The thread is more compact in structure, is high in strength, and has excellent mechanical connection, locking and sealing performances. Moreover, a physical space for machining the tapered thread is roomy.

In the dumbbell-like shaped symmetrical bidirectional tapered thread connection, pair, when the non-cusp form is selected as the connection form, a joint between the first helical conical surface of the truncated cone body and the second helical conical surface of the truncated cone body of the same helical bidirectional truncated cone body, i.e., a minor diameter of the external thread is connected by adopting an internal-cusp shaped structure and an external helical structure presented by a helically distributed groove or arc is formed; a joint between the first helical conical surface of the truncated cone body of the same helical bidirectional truncated cone body and the second helical conical surface of the truncated cone body of the adjacent bidirectional truncated cone body and/or a joint between the second helical conical surface of the truncated cone body of the same helical bidirectional truncated cone body and, the first helical conical surface of the truncated cone body of the adjacent bidirectional truncated cone body, i.e., a major diameter of the external thread is connected by adopting a non-external-cusp shaped structure and an external helical structure presented by a helically distributed flat top or arc is formed; a joint between the first helical conical surface of the tapered hole and the second helical conical surface of the tapered hole of the same helical bidirectional tapered, hole, i.e., a minor diameter of the internal thread is connected by adopting an non-external-cusp shaped structure and an internal helical structure presented by a helically distributed flat top or arc is formed; a joint between the first helical conical surface of the tapered hole of the same helical bidirectional tapered hole and the second helical conical surface of the tapered hole of the adjacent bidirectional tapered hole and/or a joint between the second helical conical surface of the tapered hole of the same helical bidirectional tapered hole and the first helical conical surface of the tapered hole of the adjacent bidirectional tapered hole, i.e., a major diameter of the internal thread is connected by adopting a non-internal-cusp shaped structure and an internal helical structure presented by a helically distributed groove or arc is formed. The non-internal-cusp refers to a geometrical shape with a cross section presented by a groove or arc, while the non-external-cusp shaped refers to a geometrical shape with a cross section presented by a plane or arc, which can avoid interference between the internal thread and the external thread during screwing, and can store oil and dirt. In actual application, the groove or arc structure may be adopted for the minor diameter of the external thread and the major diameter of the internal thread, while the cusp structure may be adopted for the major diameter of the external thread and the minor diameter of the internal thread, and/or, the plane or arc structure may be adopted for the major diameter of the external thread and the minor diameter of the internal thread, while the cusp structure may be adopted for the minor diameter of the external thread and the major diameter of the internal thread, and/or, the groove or arc structure may be adopted for the minor diameter of the external thread and the major diameter of the internal thread, while the plane or arc structure may be adopted for the major diameter of the external thread and the minor diameter of the internal thread.

During transmission connection of the dumbbell-like shaped symmetrical bidirectional tapered thread connection pair, bidirectional bearing is implemented through screwing connection of the bidirectional tapered internal thread (i.e., the bidirectional tapered hole) and the bidirectional tapered external thread (i the bidirectional truncated cone body). A clearance between the bidirectional tapered external thread and the bidirectional tapered internal thread is required. If oil and other media are lubricated between the internal thread and the external thread, a bearing oil film will be easily formed, and the clearance is beneficial to the formation of the bearing oil film. The application of the dumbbell-like shaped symmetrical bidirectional tapered thread connection pair in transmission connection is equivalent to a pair of sliding bearings consisting of one pair and/or several pairs of sliding bearings, namely, each pitch of the traditional internal thread bidirectionally contains a corresponding pitch of traditional external thread to form a pair of sliding bearings. A number of the formed sliding bearings is adjusted according to the application conditions, namely, a pitch number of containing and contained threads cohered by the effectively bidirectional jointing, i.e., effectively bidirectional contact of the traditional internal thread and the bidirectional tapered external thread, is designed according to application conditions. Through the containment of the bidirectional truncated cone body by the bidirectional, tapered hole, by virtue of positioning in multiple directions such as radial, axial, angular and circumferential, and preferably through the containment of the bidirectional truncated cone body by the bidirectional tapered hole and the main positioning in the radial and circumferential directions supplemented by the auxiliary positioning in the axial and angular directions, so as to form multidirectional positioning of the internal and external cone bodies, till the conical surface of the bidirectional tapered hole is cohered with the conical surface of the bidirectional truncated cone body to implement self-positioning or till self-locking is generated by interference fit, a special combining technology of the cone pair and the thread pair is constituted, which ensures the precision, efficiency and reliability of the transmission connection of the tapered thread technology and especially the symmetrical bidirectional tapered thread connection pair.

When the dumbbell-like shaped symmetrical bidirectional tapered thread connection pair is tightly connected and hermetically connected, technical performances thereof such as connection, locking, anti-loosening, bearing or sealing are realized through the screwing connection of the bidirectional tapered hole and the bidirectional truncated cone body, namely, the technical performances are realized through sizing of the first helical conical surface of the truncated cone body and the special conical surface of the special tapered hole till interference and/or sizing of the second helical conical surface of the truncated cone body and the second helical conical surface of the tapered hole till interference. According to application conditions, one direction bears the load and/or two directions simultaneously bear the load respectively. Namely, under the guidance of the helical line, an outer diameter of an internal cone of the bidirectional truncated cone body and an inner diameter of an external cone of the bidirectional tapered hole are centered till the first helical conical surface of the tapered hole is cohered with the first helical conical surface of the truncated cone body till one direction bears the load and/or two directions simultaneously bear the load respectively or till interference contact. In other words, through the containment of the bidirectional external cone by the bidirectional internal thread, by virtue of positioning in multiple directions such as radial, axial, angular and, circumferential, and preferably through the containment of the bidirectional truncated cone body by the bidirectional tapered hole and the main positioning in the radial and circumferential directions supplemented by the auxiliary positioning in the axial and angular directions, so as to form multidirectional positioning of the internal and external cone bodies, till the special conical surface of the bidirectional tapered hole is cohered with the conical surface of the bidirectional truncated cone body to implement self-positioning or till self-locking is generated by interference fit, a special combining technology of the cone pair and the thread pair is constituted, thus realizing technical performances such as connection, locking, anti-loosening, bearing and sealing of mechanical structures.

Therefore, the technical performances such as the transmission precision and efficiency, the load bearing capacity, the locking force of self-locking, the anti-loosening ability, the sealing performance and the reusability of the dumbbell-like shaped symmetrical bidirectional tapered thread connection pair are related to the sizes of the first helical conical surface of the truncated cone body and the formed left taper, i.e., the first taper angle α1, and the second helical conical surface of the truncated cone body and the formed right taper, i.e., the second taper angle α2, as well as the sizes of the first helical conical surface of the tapered hole and the formed left taper, i.e., the first taper angle α1, and the second helical conical surface of the tapered hole and the formed right taper, i.e., the second, taper angle α2. Material friction, coefficient, processing quality and application conditions of the columnar body and the cylindrical body also have a certain impact on the cone fit.

In the dumbbell-like shaped symmetrical bidirectional tapered thread connection pair, when the right-angled trapezoid union rotates a circle at a constant speed, an axial movement distance of the right-angled trapezoid union is at least double a length of the sum of the right-angled sides of, the two identical right-angled trapezoids. This structure ensures that the first conical surface of the truncated cone body and the second helical conical surface of the truncated cone body as well as the first helical conical surface of the tapered hole and the second helical conical surface of the tapered hole have sufficient length, thus ensuring sufficient effective contact area and intensity when the conical surface of the bidirectional truncated cone body is fitted with the conical surface of the bidirectional tapered hole as well as ensuring efficiency required by the helical movement.

In the dumbbell-like shaped symmetrical bidirectional tapered thread connection pair, when the right-angled trapezoid union rotates a circle at a constant speed, an axial movement distance of the right-angled trapezoid union is equal to a length of the sum of the right-angled sides of the two identical right-angled trapezoids. This structure ensures that the first helical conical surface of the truncated cone body and the second helical conical surface of the truncated cone body as well as the first helical conical surface of the tapered hole and the second helical conical surface of the tapered hole have sufficient length, thus ensuring sufficient effective contact area and intensity when the conical surface of the bidirectional truncated cone body is fitted with the conical surface of the bidirectional tapered hole as well as ensuring efficiency required by the helical movement.

In the dumbbell-like shaped symmetrical bidirectional tapered thread connection pair, the first helical conical surface of the truncated cone body and the second helical conical surface of the truncated cone body are continuous helical surfaces or discontinuous helical surfaces. The first helical conical surface of the tapered hole and the second helical conical surface of the tapered hole are continuous helical surfaces, or discontinuous helical surfaces. Preferably, the first helical conical surface of the truncated cone body and the second helical conical surface of the truncated cone body as well as the first helical conical surface of the tapered hole and the second helical conical surface of the tapered hole are continuous helical surfaces.

In the dumbbell-like shaped symmetrical bidirectional tapered thread connection pair, one end and/or two ends of the columnar body may be used as a screw-in end screwed into a connecting hole of the cylindrical body. A contact surface of the first helical conical surface of the truncated cone body and the first helical conical surface of the tapered hole is used as a bearing surface, and/or the first helical conical surface of the truncated cone body and the first helical conical surface of the tapered hole are in interference fit; and/or, a contact surface of the second helical conical surface of the truncated cone body and the second helical conical surface of the tapered hole is used as a bearing surface, and/or the second helical conical surface of the truncated cone body and the second helical conical surface of the tapered hole are in interference fit. The taper direction corresponding to the angle formed between two plain lines of the left conical surface of the internal thread and/or external thread here, i.e., the first helical conical surface, i.e., the first taper angle α1, is opposite to the taper direction corresponding to the angle formed between two plain lines of the right conical surface of the internal thread and/or external thread here, i.e., the second helical conical surface, i.e., the second taper angle α2. The thread connection function is realized through the contact and/or interference fit between the first helical conical surface of the internal thread and the first helical conical surface of the external thread and/or the contact and/or interference fit between the second conical surface of the internal thread and the second helical conical surface of the external thread.

In the dumbbell-like shaped symmetrical bidirectional tapered thread connection pair, a head with a size greater than an outer diameter of the columnar body is arranged at one end of the columnar body, and/or a head with a size smaller than a minor diameter of the bidirectional tapered external thread of the screw body of the columnar body is arranged at one end and/or two ends of the columnar body, and the connecting hole is a threaded hole arranged on the nut. Namely, the columnar body connected with the head herein is a bolt; and the columnar body having no head and/or having heads at both ends smaller than the minor diameter of the bidirectional tapered external thread and/or having no thread at the middle and having the bidirectional tapered external threads at both ends is a stud, and the connecting hole is arranged in the nut.

Compared with the prior art, the dumbbell-like shaped symmetrical bidirectional tapered thread connection pair has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of cone pair formed by coaxial inner and outer diameter sizing of the internal cone and the external cone until interference fit, can prevent loosening phenomenon during connection, and has self-locking and self-positioning functions.

### BRIEF DESCRIPTION OF THE DRAWINGS

FIG. 1 is a structural schematic diagram of a connection pair of a dumbbell-like shaped symmetrical bidirectional tapered thread in Embodiment 1 provided by the present invention.

FIG. 2 is a structural schematic diagram of an external thread of the dumbbell-like shaped symmetrical bidirectional tapered thread and a complete unit thread of the external thread in Embodiment 1 provided by the present invention.

FIG. 3 is a structural schematic diagram of an internal external thread of the dumbbell-like shaped symmetrical bidirectional tapered thread and a complete unit thread of the internal thread in Embodiment 1 provided by the present invention.

FIG. 4 is a structural schematic diagram of a connection pair of a dumbbell-like shaped symmetrical bidirectional tapered thread in Embodiment 2 provided by the present invention.

FIG. 5 is a structural schematic diagram of a connection pair of a dumbbell-like shaped symmetrical bidirectional tapered thread in Embodiment 3 provided by the present invention.

FIG. 6 is a structural schematic diagram of a connection pair of a dumbbell-like shaped symmetrical bidirectional tapered thread in Embodiment 4 provided by the present invention.

FIG. 7 is a structural schematic diagram of a connection pair of a dumbbell-like shaped symmetrical bidirectional tapered thread in Embodiment 5 provided by the present invention.

FIG. 8 is a graphic presentation of that the thread of the existing thread technology is an inclined plane on a cylindrical or conical surface involved in the background of the present invention.

FIG. 9 is a graphic presentation of that “an inclined plane slider model of the principle of the existing thread technology-the principle of inclined plane” involved in the background of the present invention.

FIG. 10 is a graphic presentation of “a thread rise angle of the existing thread technology” involved in the background of the present invention

In the figures, tapered thread 1, cylindrical body 2 nut body 21, nut body 22, columnar body 3, screw body 31, tapered hole 4, bidirectional tapered hole 41, conical surface 42 of the bidirectional, tapered hole, first helical conical surface 421 of the tapered hole, first taper angle α1, second helical conical surface 422 of the tapered hole, second taper angle α2, internal helical line 5 internal thread 6, groove 61 of the bidirectional tapered internal thread, plane or arc 62 of the bidirectional tapered internal thread, truncated cone body 7, bidirectional truncated cone body 71, conical surface 72 of the bidirectional truncated cone body, first helical conical surface 721 of the truncated cone body, first taper angle α1 second helical conical surface 722 of the truncated cone body, second taper angle α2, external helical line 8, external thread 9, groove 91 of the bidirectional tapered external thread, plane or arc 92 of the bidirectional tapered external thread dumbbell-like shape 94, left taper 95, right taper 96, left-direction distribution 97, right-direction distribution 98, thread connection pair and/or thread pair 10, clearance 101, cone axis 01, thread axis 02, slider A on the inclined surface, inclined surface B, gravity G, gravity component G1 along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION OF PREFERRED EMBODIMENTS

The present invention will be further described in detail below with reference to the accompany drawings and specific embodiments.

### Embodiment 1

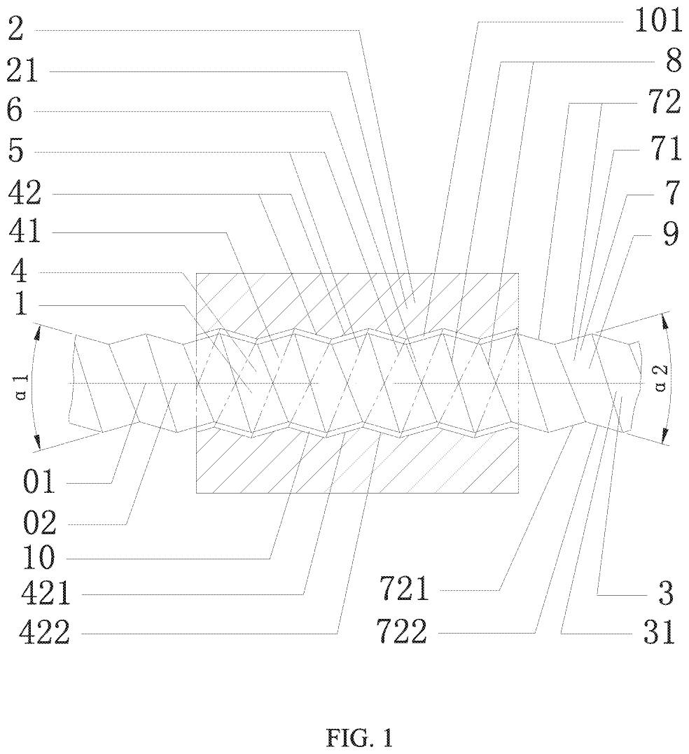

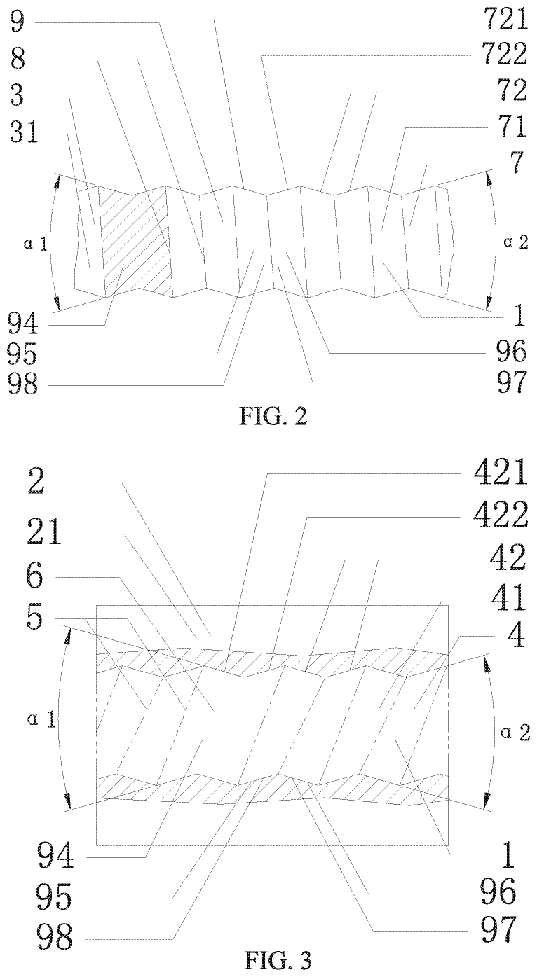

As shown in FIGS. 1 to 3, the bell-like shaped symmetrical bidirectional tapered thread connection pair comprises a bidirectional truncated cone body 71 helically distributed on an outer surface of a columnar body 3, and a bidirectional tapered hole 41 helically distributed on an inner surface of a cylindrical body 2, i.e., comprises an external thread 9 and an, internal thread 6 in mutual thread fit, wherein the internal thread 6 is, presented by the helical bidirectional tapered hole 41 and exists in a form of a “non-entity space”, while the external thread 9 is presented, by the helical bidirectional truncated cone body 71 and exists in a form of a “material entity”. The internal thread 6 and the external thread 9 are in a relationship of a containing part and a contained part: the internal thread 6 and the external thread 9 are sleeved together by screwing bidirectional tapered geometries in pitches and cohered till interference fit. The bidirectional tapered hole 41 contains the bidirectional truncated cone body 71 in pitches. The bidirectional containment limits a disordered degree of freedom between the tapered hole 4 and the truncated cone body 7; and the helical movement enables the symmetrical bidirectional tapered thread connection pair 10 to obtain a necessary ordered degree of freedom, thus effectively combining technical characteristics of a cone pair and a thread pair.

When the dumbbell-like shaped symmetrical bidirectional tapered thread connection pair in the embodiment is used, a conical surface 72 of the directional truncated cone body and a conical surface 42 of the bidirectional tapered hole are in mutual fit.

The symmetrical bidirectional tapered thread connection pair 10 has the self-locking and self-positioning performances only if the truncated cone body 7 and/or the tapered hole of the dumbbell-like shaped symmetrical bidirectional tapered thread connection pair in the embodiment reaches a certain taper, the cone body forming the cone pair reaches, a certain taper angle. The taper comprises a left taper 95 and a right taper 96. The taper angle comprises a left taper angle and a right taper angle. The left taper 95 corresponds to the left taper angle, i.e. a first taper angle α1. It is preferable that the first taper angle α1 is greater than 0° and smaller than 53°; and preferably, the first taper angle α1 is 2°-40°. The right taper 96 corresponds to the right taper angle, i.e., a second taper angle α1. It is preferable that the second taper angle α2 is greater than 0° and smaller than 53°; and preferably, the second taper angle α2 is 2°-40°. In individual special fields, transmission connection application fields without self-locking and/or with low requirements on self-positioning performances and/or with high requirements on axial bearing capacity, it is preferable that the first taper angle α1 is greater than or equal to 53° and smaller than 180°, and the second taper angle α2 is greater than or equal to 53° and smaller than 180°.

The external thread 9 is arranged on the outer surface of the columnar body 3, wherein the columnar body 3 is provided with a screw body 31. The truncated cone body 7 is helically distributed on an outer surface of the screw body 31, comprising a symmetrical bidirectional truncated cone body 71. The symmetrical bidirectional truncated cone body 71 is a dumbbell-like shaped 94 special bidirectional tapered geometry. The columnar body 3 may be solid or hollow, comprising a cylinder, a cone body, a tubular body, and the like.

The dumbbell-like shaped 94 symmetrical bidirectional truncated cone body 71 is formed by oppositely jointing two symmetrical upper sides of two identical truncated cone, bodies, and lower sides of the two identical truncated cone bodies are located at two ends of the bidirectional truncated cone body 71 and are mutually jointed with the lower sides of the adjacent bidirectional truncated cone body 71 and/or to be mutually jointed with the lower sides of the adjacent bidirectional truncated cone body 71. A conical surface 72 of the symmetrical bidirectional truncated cone body is arranged on an outer surface of the truncated cone body 7. The external thread 9 comprises a first helical conical surface 721 of the truncated cone body, a second helical conical surface 722 of the truncated cone body and an external helical line 8. In a cross section through, which the thread axis 02 passes, the complete single-pitch symmetrical bidirectional tapered external thread 9 is a dumbbell-like shaped 94 special bidirectional tapered geometry small in the middle and large in both ends and having a left taper same as and/or approximately same as a right taper. An angle formed between two plain lines of a left conical surface of the bidirectional truncated cone body 71, i.e., the first helical conical surface 721 of the truncated cone body, is the first taper angle α1. The left taper 95 is formed on the first helical conical surface 721 of the truncated cone body, corresponds to the first taper angle α1, and is subjected to a right-direction distribution 98. An angle formed between two plain lines of a right conical surface of the symmetrical bidirectional truncated cone body 71, i.e., the second helical conical surface 722 of the truncated cone body, is the second taper angle α2. The right taper 96 is formed on the second helical conical surface 722 of the truncated cone body, corresponds to the second taper angle α2, and is subjected to a left-direction distribution 97. The taper directions corresponding to the first taper angle α1 and the second taper angle α2 are opposite. The plain line is an intersection line of the conical surface and the plane through which the cone axis 01 passes. A shape formed by the first helical conical surface 721 of the truncated cone body and the second helical conical surface 722 of the truncated cone body of the bidirectional truncated cone body 71 is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the columnar body 3; wherein the right-angled trapezoid union refers to a special geometry formed by oppositely jointing two symmetrical upper sides of two identical right-angled trapezoids, and lower sides of the two identical right-angled trapezoids are respectively located at two ends of the right-angled trapezoid union; and the two right-trapezoids are coincident with the central axis of the columnar body 3.

The internal thread 6 is arranged on the inner surface of the cylindrical body 2, wherein the cylindrical body 2 is provided, with a nut body 21, a tapered hole 4 is helically distributed on an inner surface of the nut body 21, comprising a symmetrical bidirectional tapered hole 41. The symmetric bidirectional tapered hole 41 is a dumbbell-like shaped 94 special bidirectional tapered geometry, and the cylindrical body comprises cylindrical and/or non-cylindrical workpieces and objects that need to be machined with internal threads on inner surfaces thereof.

The dumbbell-like shaped 94 symmetrical bidirectional tapered hole 41 is formed by oppositely jointing two symmetrical upper sides of two identical tapered holes, and lower sides of the two identical tapered holes are located at two ends of the bidirectional tapered hole 41 and are mutually jointed with the lower sides of the adjacent symmetrical bidirectional tapered hole 41 and/or to mutually jointed with the lower sides of the adjacent symmetrical bidirectional tapered hole 41. The tapered hole 4 comprises a conical surface 42 of the symmetrical bidirectional tapered hole. The internal thread 6 comprises a first helical conical surface 421 of the tapered hole, a second helical conical surface 422 of the tapered hole and an internal helical line 5. In a cross section through which the thread axis 02 passes, the complete single-pitch symmetrical bidirectional tapered internal thread is a dumbbell-like shaped 94 special bidirectional tapered geometry small in the middle and large in both ends and having a left taper same as and/or approximately same as a right taper. An angle formed between two plain lines of a left conical surface of the bidirectional tapered hole 41, i.e., the first helical conical surface 421 of the tapered hole, is the first taper angle α1. The left taper 95 is formed on the first helical conical surface 421 of the tapered hole, corresponds to the first taper angle α1, and is subjected to a right-direction distribution 98. An angle formed between two plain lines of a right conical surface of the bidirectional tapered hole 41, i.e., the second helical conical surface 422 of the tapered hole, is the second taper angle α2. The right taper 96 is formed on the second helical conical surface 422 of the tapered hole, corresponds to the second taper angle α2, and is subjected to a left-direction distribution 97. The taper directions corresponding to the first taper angle α1 and the second taper angle α2 are opposite. The plain line is an intersection line of the conical surface and the plane through, which the cone axis 01 passes. A shape formed by the first helical conical surface 421 of the tapered hole and the second helical conical surface 422 of the tapered hole of the bidirectional tapered hole 41 is the same as a shape of a helical outer flank of a rotating body, wherein the rotating body is formed by two, hypotenuses of a right-angled trapezoid union being rotated around a right-angled side of the right-angled trapezoid union, and, at the same time, the right-angled trapezoid union axially moves at a constant speed along a central axis of the cylindrical body 2; wherein the right-angled trapezoid union refers to a special geometry formed by oppositely jointing two symmetrical upper sides of two identical right-angled trapezoids, and lower sides of the two identical right-angled trapezoids are respectively located at two ends of the right-angled trapezoid union; and the two right-trapezoids are coincident with the central axis of the cylindrical body 2.

In the dumbbell-like shaped symmetrical bidirectional tapered thread connection pair of the embodiment, a joint of two adjacent helical conical surfaces of the external thread 9 and a joint of two adjacent helical conical surfaces of the internal thread 6 respectively are connected through connection form such as cusp and/or non-cusp forms, and the cusp form is relative to the non-cusp form, which refers to a structural form which is not specially subjected to non-cusp treatment.

According to the dumbbell-like shaped 94 bidirectional truncated cone body 71 and the dumbbell-like shape 94 bidirectional tapered hole 41, a joint between the first helical conical surface 721 of the truncated cone body and the second helical conical surface 722 of the truncated cone body of the same helical bidirectional truncated cone body 71, i.e., a minor diameter of the external thread 9 is connected by adopting an internal-cusp shaped structure and the helically distributed external helical line 8 is formed; a joint between the first helical conical surface 721 of the truncated cone body of the same helical bidirectional truncated cone body 71 and the second helical conical, surface 722 of the truncated cone body of the adjacent bidirectional truncated cone body 71 and/or a joint between the second helical conical surface 722 of the truncated, cone body of the same helical bidirectional truncated cone body 71 and the first helical conical surface 721 of the truncated cone body of the adjacent bidirectional truncated cone body 71, i.e., a major diameter of the external thread 9 is connected by adopting an external-cusp shaped structure and, the helically distributed external helical line 8 is formed. A joint between the first helical conical surface 421 of the tapered hole and the second helical conical surface 422 of the tapered hole of the same helical bidirectional tapered hole 41, i.e., a minor diameter of the internal thread 6 is connected by adopting an external-cusp shaped structure and the helically distributed internal helical line 5 is formed; a joint between the first helical conical surface 421 of the tapered hole of the same helical bidirectional tapered hole 41 and the second helical conical surface 422 of the tapered hole of the adjacent bidirectional tapered hole 41 and/or a joint between the second helical comical surface 422 of the truncated cone body of the same helical bidirectional tapered hole 41 and the first helical conical surface 421 of the tapered hole of the adjacent bidirectional tapered hole 41. i.e., a major diameter of the internal thread 6 is connected by adopting an internal-cusp shaped structure and the helically distributed internal helical line 5 is formed. The tapered thread 1 is more compact in structure, is high in strength, and has excellent mechanical connecting, locking and sealing performances. Moreover, a physical space for machining the tapered thread is roomy.

During transmission connection of the dumbbell-like shaped symmetrical bidirectional tapered, thread connection pair in the embodiment, bidirectional bearing is implemented through screwing connection of the bidirectional tapered hole 41 and the bidirectional truncated cone body 71. A clearance 101 between the bidirectional truncated cone body 71 and the bidirectional tapered hole 41 is required. If oil and other media are lubricated between the internal thread 6 and the external thread 9, a bearing oil film will be easily formed, and the clearance 101 is beneficial to the formation of the bearing oil film. The symmetrical bidirectional tapered thread connection, pair 10 is equivalent to a pair of sliding bearings consisting of one pair and/or several pairs of sliding bearings, namely, each pitch of the traditional internal thread 6 bidirectionally contains a corresponding pitch of traditional external thread 9 to form a pair of sliding bearings. A number of the formed sliding bearings is adjusted according to the application conditions, namely, a pitch number of containing and contained threads cohered by the effectively bidirectional jointing of the bidirectional tapered internal thread 6 and the bidirectional tapered external thread 9 is designed according to application conditions. Through the containment of the bidirectional external cone 9 by the bidirectional internal cone 6, by virtue of positioning in multiple directions such as radial, axial, angular and circumferential, and preferably through the containment of the bidirectional truncated cone body by the bidirectional tapered hole and the main positioning in the radial and circumferential directions supplemented by the auxiliary positioning in the axial and angular directions, a special combining technology of the cone pair and the thread pair is constituted, which ensures the precision, efficiency and reliability of the transmission connection of the tapered thread technology and especially the dumbbell-like shaped symmetrical bidirectional tapered thread connection pair 10.

When the dumbbell-like shaped symmetrical bidirectional tapered thread connection pair in the embodiment is tightly connected and hermetically connected, technical performances thereof such as connection, locking, anti-loosening, bearing, fatigue and sealing are realized through the screwing connection of the bidirectional tapered hole 41 and the bidirectional truncated cone body 71, namely, the technical performances are realized through sizing of the first helical conical surface 721 of the truncated cone body and the first helical conical surface 421 of the tapered hole till interference and/or sizing of the second helical conical surface 722 of the truncated cone body and the second helical conical surface 422 of the tapered hole till interference. According to application conditions, one direction bears the load uniaxially and/or two directions simultaneously respectively bear the load uniaxially. Namely, under the guidance of the helical line, an outer diameter of an internal cone of the bidirectional truncated cone body 71 and an inner diameter of an external cone of the bidirectional tapered hole 41 are centered till the first helical conical surface 421 of the tapered hole is cohered with the first helical conical surface 721 of the truncated cone body till interference contact and/or the second helical conical surface 422 of the tapered hole is connected with the second helical conical surface 722 of the truncated cone body till interference contact, thus realizing, technical performances such as connection, locking, anti-loosening, hearing, fatigue and sealing of mechanical fastening structures.

Therefore, the technical performances such as the transmission precision and efficiency, the load bearing capacity, the locking force of self-locking, the anti-loosening ability, the sealing performance and the reusability of the dumbbell-like shaped symmetrical bidirectional tapered thread connection pair in the embodiment are related to the sizes of the first helical conical surface 721 of the truncated cone body and the formed left taper 95, i.e., the first taper angle α1, and the second helical conical surface 722 of the truncated cone body and the formed right taper 96, i.e., the second taper angle α2, as well as the sizes of the first helical conical surface 421 of the tapered hole and the formed left taper 95, i.e., the first taper angle α1, and the second helical, conical surface 422 of the tapered hole and the formed right taper 96, i.e., the second taper angle α2. Material friction coefficient, processing quality and application conditions of the columnar body 3 and the cylindrical body 2 also have a certain impact on the cone fit.

In the dumbbell-like shaped symmetrical bidirectional tapered thread connection pair, when the right-angled trapezoid union rotates a circle at a constant speed, an axial movement distance of the right-angled trapezoid union is at least double a length of the sum of the right-angled sides of the two identical right-angled trapezoids. The structure ensures that the first helical conical surface 721 of the truncated cone body and the second helical conical surface 722 of the truncated cone body as well as the first helical conical surface 421 of the tapered hole and the second helical conical surface 422 of the tapered hole have sufficient length, thereby, ensuring that the conical surface 72 of the bidirectional truncated cone body and the conical surface 42 of the bidirectional tapered hole have sufficient effective contact area and strength and the efficiency required by helical movement during fitting.

In the dumbbell-like shaped symmetrical bidirectional tapered thread connection pair, when the right-angled trapezoid union rotates a circle at a constant speed, an axial movement distance of the right-angled trapezoid union is equal to a length of the sum of the right-angled sides of the two identical right-angled trapezoids. The structure ensures that the first helical conical surface 721 of the truncated cone body and the second helical conical surface 722 of the truncated cone body as well as the first helical conical surface 421 of the tapered hole and the second helical conical surface 422 of the tapered hole have sufficient length, thereby ensuring that the conical surface 72 of the bidirectional truncated cone body and the conical surface 42 of the bidirectional tapered hole have sufficient effective contact area and strength and the efficiency required by helical movement during fitting.

In the dumbbell-like shaped symmetrical bidirectional tapered thread connection pair, the first helical conical surface 721 of the truncated cone body and the second helical conical surface 722 of the truncated cone body are continuous helical surfaces or discontinuous helical surfaces. The first helical conical surface 421 of the tapered hole and the second helical conical surface 422 of the tapered hole are continuous helical surfaces or discontinuous helical surfaces. Preferably, the first helical conical surface 721 of the truncated cone body and the second helical conical surface 722 of the truncated cone body as well as the first helical conical surface 421 of the tapered hole and the second helical conical surface 422 of the tapered hole are continuous helical surfaces.

In the dumbbell-like shaped symmetrical bidirectional tapered thread connection pair, one end and/or two ends of the columnar body 3 may be used as a screw-in end screwed into a connecting hole of the cylindrical body 2.

In the dumbbell-like shaped symmetrical bidirectional tapered thread connection pair, a head with a size greater than an outer diameter of the columnar body 3 is arranged at one end of the columnar body 3, and/or a head with a size smaller than a minor diameter of the bidirectional tapered external thread 9 of the screw body 31 of the columnar body 3 is arranged at one end and/or two ends of the columnar body 3, and the connecting hole is a threaded hole arranged on the nut body 21. Namely, the columnar body 3 connected with the head herein is a bolt; and the columnar body having no head and/or having, heads at both ends smaller than the minor diameter of the bidirectional tapered external thread 9 and/or having no thread at the middle and having the bidirectional tapered external threads 9 at both ends is a stud, and the connecting hole is arranged in the nut 21.

Compared with the prior art, the dumbbell-like shaped symmetrical bidirectional tapered thread connection pair has the advantages of reasonable design, simple structure, convenient operation, large locking force, high bearing capacity, excellent anti-loosening performance, high transmission efficiency and precision, good mechanical sealing effect and good stability, realizes the fastening and connecting functions through sizing of the cone pair formed by the internal cone and the external cone until interference fit, can prevent loosening phenomenon during connection, and has self-locking and self-positioning functions.

### Embodiment 2

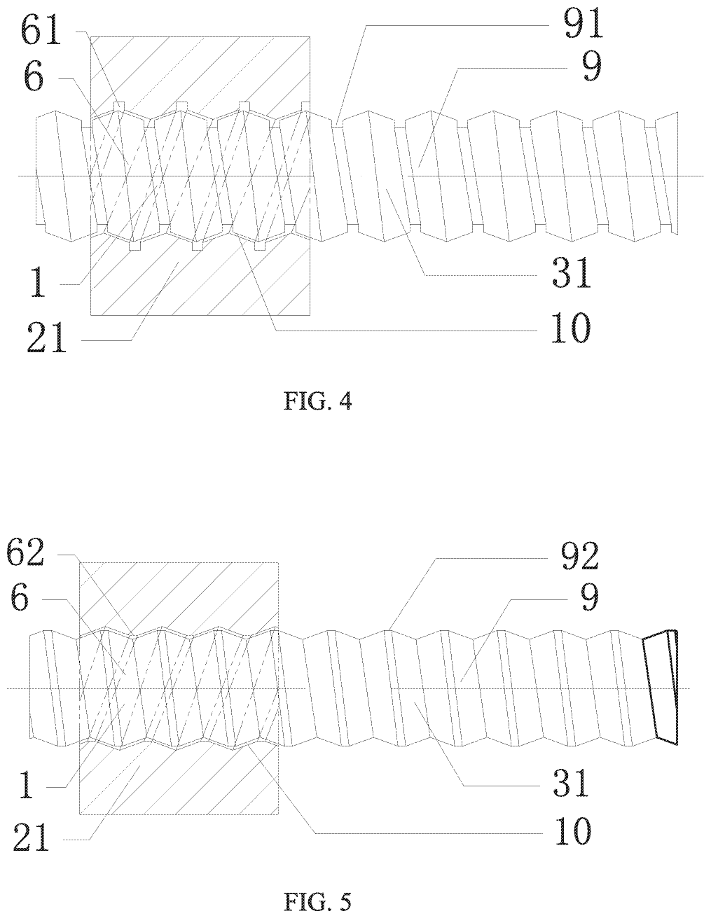

As shown in FIG. 4, the structure, principle and implementation steps of the embodiment are similar to that in Embodiment 1, and the differences are that a minor diameter of the external thread 9 is treated by a groove 91 connected external helical structure, the external helical structure is a special external helical line 8, a major diameter of the internal thread 6, i.e., a joint of the adjacent helical conical surface is treated by a groove 61 connected internal helical structure, and the internal helical structure is a special internal helical line 5, which can avoid interference between the internal thread 6 and the external thread 9 during screwing, and can also store oil and dirt.

### Embodiment 3

As shown in FIG. 5, the structure, principle and implementation steps of the embodiment are similar to that in Embodiment 1, and the differences are that a major diameter of the external thread 9, i.e., a joint of the adjacent conical surface is treated by a plane or arc 92 connected external helical structure, the external helical structure is a special external helical line 8, a minor diameter of the internal thread 6 is treated by a plane or arc 62 connected internal helical structure, and the internal helical structure is a special internal helical line 5, which can avoid interference between the internal thread 6 and the external thread 9 during screwing, and can, also store oil and dirt.

### Embodiment 4

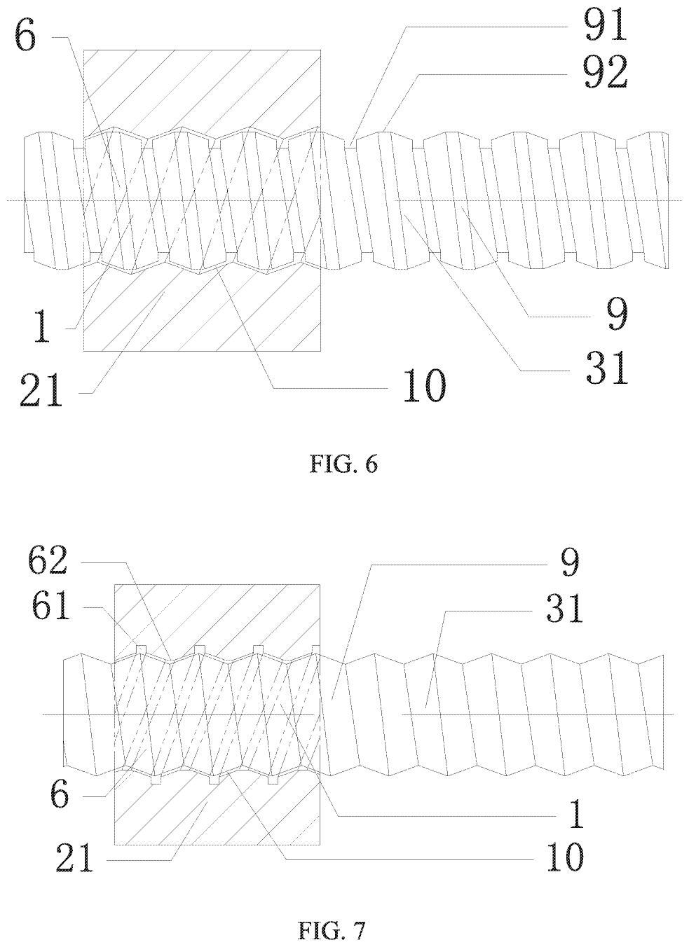

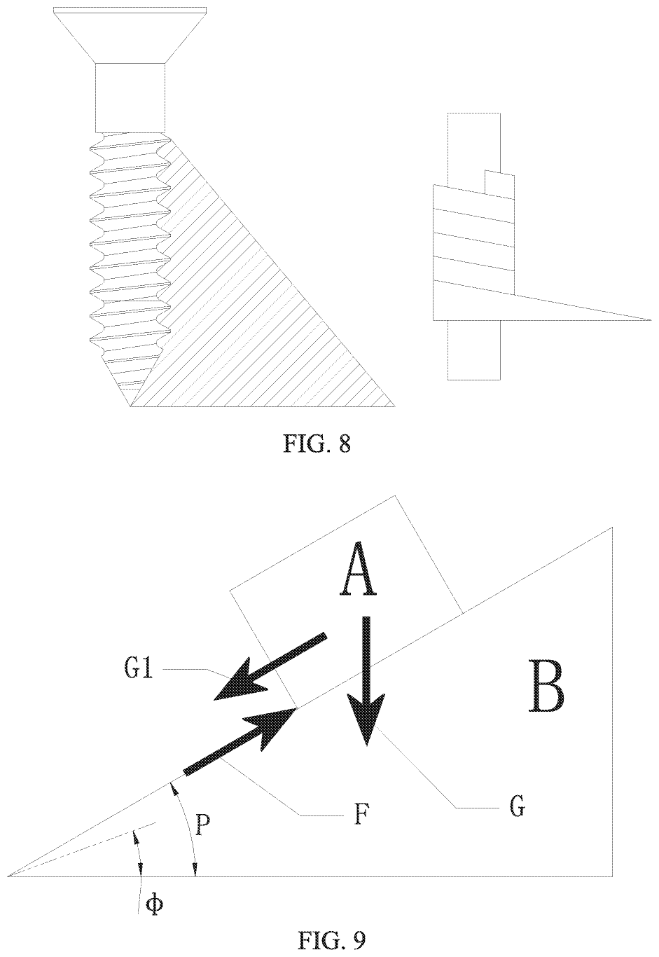

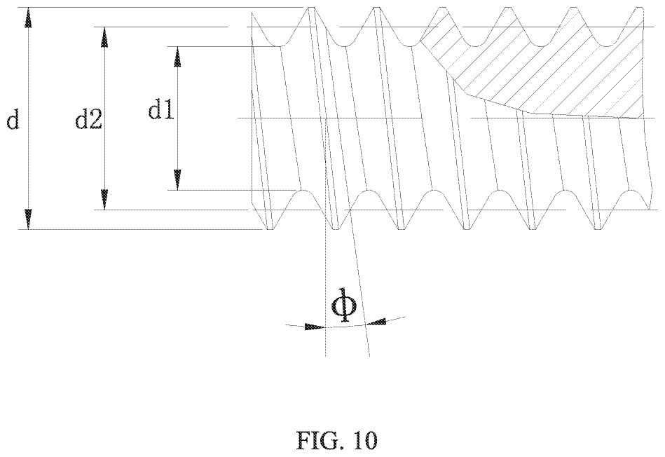

As shown in FIG. 6, the structure, principle and implementation steps of the embodiment are similar to that in Embodiment 1, and the differences are that a minor diameter of the external thread 9 is treated by a groove 91 connected external helical structure, a major diameter of the external thread 9, i.e., a joint of the adjacent helical conical surface is treated by a plane or arc 92 connected external helical structure, the external helical structure is a special external helical line 8, both a major diameter and a minor diameter of the internal thread 6 forming the thread pair 10 together with the external thread 9 are connected by a cusp form, which can avoid an R angle possibly caused by forming the thread pair 10, and can avoid interference between the internal, thread 6 and the external thread 9 during screwing, and can also store oil and dirt.

### Embodiment 5

As shown in FIG. 7, the structure, principle and implementation steps of the embodiment are similar to that in Embodiment 1, and the differences are that a major diameter of the internal thread 6, i.e., a joint of the adjacent helical conical surface is treated by a groove 61 connected internal helical structure, a minor diameter of the internal thread 6 is treated by a plane or arc 62 connected internal helical structure, the internal helical structure is a special internal helical line 5, both a major diameter and a minor diameter of the external thread 9 forming the thread pair 10 together with the internal thread 6 are connected by a cusp form, which can avoid an R angle possibly caused by forming the thread pair 10, and can avoid interference between the internal thread 6 and the external thread 9 during screwing, and can also store, oil and dirt.

The specific embodiments described herein are merely examples to illustrate the spirit of the present invention. Those skilled in the art of the present invention can make various modifications or supplements to the specific embodiments described or substitute with similar modes without deviating from the spirit of the present invention or going beyond the scope defined by the appended claims.

The terms such as tapered thread 1, cylindrical body 2, nut body 21, nut body 22, columnar body 3, screw body 31, tapered hole 4, bidirectional tapered hole 41, conical surface 42 of the bidirectional tapered hole, first helical conical surface 421 of the tapered hole, first taper angle α1, second helical conical surface 422 of the tapered hole, second taper angle α2, internal helical line 5, internal thread 6, groove 61 of the bidirectional tapered internal thread, plane or arc 62 of the bidirectional tapered internal thread, truncated cone body 7, bidirectional truncated cone body 71, conical surface 72 of the bidirectional truncated cone body, first helical conical surface 721 of the truncated cone body, first taper angle α1, second helical conical surface 722 of the truncated cone body, second taper angle α2, external helical line 8, external thread 9, groove 91 of the bidirectional tapered external thread, plane or arc 92 of the bidirectional tapered external thread dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, shaft sleeve, shaft, non-entity space, material entity, single tapered body, double tapered body, cone body, internal cone body, tapered hole, external cone body, tapered body, cone pair, helical structure, helical movement, thread body, complete unit thread, axial force, axial force angle, counter-axial force, counter-axial force angle, centripetal force, counter-centripetal force, inversely collinear, internal stress, bidirectional force, unidirectional force, sliding bearing, sliding bearing pair are widely used, but the possibility of using other terms is not excluded. These terms are merely used to describe and explain the essence of the present invention more conveniently; and it is contrary to the spirit of the present invention to interpret the terms as any additional limitation.

We claim:

1. A dumbbell-like shaped symmetrical bidirectional tapered thread connection pair, comprising an external thread (9) and an internal thread (6) in mutual thread fit, wherein:
a complete unit thread of the dumbbell-like shaped symmetrical bidirectional tapered thread (1) is a helical dumbbell-like shaped symmetrical bidirectional tapered body small in the middle and large in both ends and comprising a bidirectional tapered hole (41) and/or a bidirectional truncated cone body (71);
a thread body of the internal thread (6) is the helical bidirectional tapered hole (41) on an inner surface of a cylindrical body (2), and exists in a form of a “non-entity space”;
a thread body of the external thread (9) is the helical bidirectional truncated cone body (71) on an outer surface of a columnar body (3), and exists in a form of a “material entity”;
a left taper (95) is formed on a left conical surface of the symmetrical bidirectional tapered body and corresponds to a first taper angle (α1), and a right taper (96) is formed on a right conical surface of the symmetrical bidirectional tapered body and corresponds to a second taper angle (α2);
the left taper (95) and the right taper (96) have opposite directions, and same and/or approximately same tapers; and
the internal thread (6) and the external thread (9) contain the bidirectional truncated cone body by the bidirectional tapered hole till an inner conical surface of the bidirectional tapered hole and an outer conical surface of the bidirectional truncated cone body bear each other.

2. The thread connection pair according to claim 1, wherein the dumbbell-like shaped bidirectional tapered internal thread (6) comprises a left conical surface of a conical surface (42) of the bidirectional tapered hole, i.e., a first helical conical surface (421) of the tapered hole, a right conical surface of the conical surface (42) of the bidirectional tapered hole, i.e., a second helical conical surface (422) of the tapered hole, and an internal helical line (5);
a shape formed by the first helical conical surface (421) of the tapered hole and the second helical conical surface (422) of the tapered hole, i.e., a bidirectional helical conical surface, is the same as a shape of a helical outer, flank of a first rotating body, wherein the first rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body (2); wherein the right-angled trapezoid union is formed by oppositely jointing two symmetrical upper sides of two identical right-angled trapezoids; and the two right-trapezoids are coincident with the central axis of the cylindrical body (2);
the dumbbell-like shaped bidirectional tapered external thread (9) comprises a left conical surface of a conical surface (72) of the bidirectional truncated cone body, i.e., a first helical conical surface (721) of the truncated cone body, a right conical surface of the conical surface (72) of the bidirectional truncated cone body, i.e., a second helical conical surface (722) of the truncated cone body, and an external helical line (8); and
a shape formed by the first helical conical surface (721) of the truncated cone body and the second helical conical surface (722) of the truncated cone body, i.e., a bidirectional helical conical surface is the same as a shape of a helical outer flank of a second rotating body, wherein the second rotating body is formed by two hypotenuses of a right-angled trapezoid union being rotated around a right-angled side of the right-angled trapezoid union, and, at the same time, the right-angled trapezoid union axially moves at a constant speed along a central axis of the columnar body (3); wherein the right-angled trapezoid union is formed by oppositely jointing two symmetrical upper sides of two identical right-angled trapezoids; and the two right-trapezoids are coincident with the central axis of the columnar body (3).

3. The thread connection pair according to claim 2, when the right-angled trapezoid union rotates a circle at a constant speed, an axial movement distance of the right-angled trapezoid union is at least double a length of the sum of the right-angled sides of the two right-angled trapezoids of the right-angled trapezoid union.

4. The thread connection pair according to claim 2, when the right-angled trapezoid union rotates a circle at a constant speed, an axial movement distance of the right-angled trapezoid union is equal to a length of the sum of the right-angled sides of the two right-angled trapezoids of the right-angled trapezoid union.

5. The thread connection pair according to claim 2, wherein the left conical surface and the right conical surface of the bidirectional tapered body, i.e., the first helical conical surface (421) of the tapered hole and the second helical conical surface (422) of the tapered hole, and the internal helical line (5) are continuous helical surfaces or discontinuous helical surfaces; and
the first helical conical surface (721) of the truncated cone body, the second helical conical surface (722) of the truncated cone body, and the external helical line (8) are continuous helical surfaces or discontinuous helical surfaces.

6. The thread connection pair according to claim 1, wherein the internal thread (6) is formed by oppositely jointing two symmetrical upper sides of two identical tapered holes (4), wherein bottom sides of the two tapered holes (4) are located at two ends of the bidirectional tapered hole (41) and are respectively jointed with lower sides of the adjacent bidirectional tapered hole (41); and
the external thread (9) is formed by oppositely jointing symmetrical upper sides of two identical truncated cone bodies (7), wherein lower sides of the two truncated cone bodies (7) are located at two ends of the bidirectional truncated cone body (71) and are respectively jointed with lower sides of the adjacent bidirectional truncated cone body (71).

7. The thread connection pair according to claim 1, wherein, an external-cusp shaped structure is adopted for a major diameter of the external thread (9), an internal-cusp shaped structure is adopted for a minor diameter of the external thread (9), an internal-cusp shaped structure is adopted for a major diameter of the internal thread (6), and an external-cusp shaped structure is adopted for a minor diameter of the internal thread (6); and/or
a groove (91) structure is adopted for the minor diameter of the external thread (9), a groove (61) is adopted for the major diameter of the internal thread (6), while the cusp shaped structure is maintained for the major diameter of the external thread (9) and the minor diameter of the internal thread (6); and/or
a plane, or arc (92) structure is adopted for the major diameter of the external thread (9), a plane or arc (62) structure is adopted for the minor diameter of the internal thread (6), while the cusp shaped structure maintained for the minor diameter of the external thread (9) and the major diameter of the internal thread (6); and/or
the groove (91) structure is adopted for the minor diameter of the external thread (9), the groove (61) structure is adopted for the major diameter of the internal thread (6), while the plane or arc (62) structure is maintained for the major diameter of the external thread (9) and the minor diameter of the internal thread (6).

8. The thread connection pair according to claim 1, wherein the internal thread (6) and the external thread (9) form a thread pair (10);
the thread pair (10) is formed by a plurality of cone pairs; and each of the cone pair is formed by the helical bidirectional tapered hole (41) and the helical bidirectional truncated cone body (71) in mutual fit;
a clearance (101) is provided between the bidirectional truncated cone body (71) and the bidirectional tapered hole (41);
each internal thread (6) contains a corresponding external thread (9) and are coaxially centered to form a pair of sliding bearings, and the entire thread connection pair (10) is composed of one pair or several pairs of sliding bearings;
a pitch number of containing and contained threads cohered by the effectively bidirectional jointing, i.e., effectively bidirectional contact of the internal thread (6) and the external thread (9) is designed according to application conditions;
the tapered hole (4) of the internal thread (6) bidirectionally contains the truncated cone body (7) of the external thread (9); and
each internal thread (6) and each external thread (9) comprise bidirectional bearing in one side and/or bidirectional bearing in left and right sides.

9. The thread connection pair according to claim 1, wherein the internal thread (6) and the external thread (9) form a thread pair (10); and
a contact surface between the first helical conical surface (421) of the tapered hole and the first helical conical surface (721) of the truncated cone body in mutual fit as well as a contact surface between the second helical conical surface (422) of the tapered hole and the second helical conical surface (722) of the truncated cone body in mutual fit are used as bearing surfaces; an outer diameter of an internal cone and an inner diameter of an external cone are centered under the guidance of the helical line till the conical surface (42) of the bidirectional tapered hole and the conical surface (72) of the bidirectional truncated cone body are cohered till the helical conical surface bears a load in one direction and/or the helical conical surface bears the load in two directions and/or till self-positioning generated by self-positioning contact and/or interference contact.

10. The thread connection pair according to claim 1, wherein the columnar body (3) is solid or hollow, comprising cylindrical and/or non-cylindrical workpieces and objects which need to be machined with the bidirectional tapered external threads (9) on outer surfaces thereof;
the cylindrical body (2) comprises cylindrical and/or non-cylindrical workpieces and objects which need to be machined with the bidirectional tapered internal threads (6) on inner surfaces thereof; and
the outer surfaces and/or inner surfaces comprise geometric shapes of surfaces such as cylindrical surfaces and/or non-cylindrical surfaces such as conical surfaces.

11. The thread connection pair according to claim 1, wherein the internal thread (6) and/or the external thread (9) comprises a single thread body which an incomplete tapered geometry, that is, the single thread body an incomplete unit thread.

12. The thread connection pair according to claim 1, wherein the first taper angle (α1) is greater than 0° and smaller than 53° and the second taper angle (α2) is greater than 0° and smaller than 53°; and/or, the first taper angle (α1) is greater than or equal to 53° and smaller than 180°, and the second taper angle (α2) is greater than or equal to 53° and smaller than 180°.
